(19) United States
(12) Patent Application Publication
(10) Pub. No.: US 2026/0067414 A1
(43) Pub. Date: Mar. 5, 2026

(54) EFFICIENT SHOT DETECTION OF TRANSITIONS

(71) Applicant: Microsoft Technology Licensing, LLC, Redmond, WA (US)

(72) Inventors: Yonit HOFFMAN, Herzliya (IL); Zvi FIGOV, Modiin (IL); Eliyahu STRUGO, Jerusalem (IL)

(73) Assignee: Microsoft Technology Licensing, LLC, Redmond, WA (US)

(21) Appl. No.: 19/094,188

(22) Filed: Mar. 28, 2025

Related U.S. Application Data
(60) Provisional application No. 63/689,506, filed on Aug. 30, 2024.

(51) Int. Cl. H04N 5/14; G06V 10/74; G06V 10/82; G06V 20/40

(52) U.S. Cl. CPC H04N 5/147; G06V 10/761; G06V 10/82; G06V 20/46

(57) ABSTRACT

Systems and methods for providing efficient shot transition detection for shot segmentation of a video. A traditional shot transition detector and a neural network shot transition detector are used in multiple stages to identify transitions between shots in the video. Further, dynamic thresholds are determined based on visual attributes of the video that are used to detect cut transitions and gradual transitions.

### CROSS-REFERENCE TO RELATED APPLICATIONS

This application claims the benefit of U.S. Provisional Ser. No. 63/689,506, titled “EFFICIENT SHOT DETECTION OF TRANSITIONS,” filed Aug. 30, 2024, which is incorporated by reference herein in its entirety.

### BACKGROUND

In the context of videos, and in the media domain, segmenting a video into individual shots is a fundamental process in the analysis and comprehension of the video's content. For instance, shots can be analyzed and characterized based on content, duration, and/or other attributes that provide a basis for further analysis and understanding of the video. Typically, a shot is a continuous sequence of frames captured by a single camera of a specific angle, location, and/or character(s). A transition from one shot to a next shot can be via a cut transition, which is characterized by an abrupt change without a transition effect, or a gradual transition, such as a zoom, fade, dissolve, flip, pan, etc., between shots that occurs over multiple frames.

It is with respect to these and other considerations that examples have been made. In addition, although relatively specific problems have been discussed, it should be understood that the examples should not be limited to solving the specific problems identified in the background.

### SUMMARY

Examples of the present disclosure relate to a shot segmentation system and method for efficiently detecting shots and transitions between shots in videos. In some implementations, a multistage shot detection technique utilizing dynamic thresholds is used to optimize computational resources. For instance, a first shot transition detector is used to generate a set of candidate shot transitions in a video based on a first threshold. A second shot transition detector that has higher accuracy and uses more computational resources than the first transition detector is then used to process the set of shot transition candidates (rather than all frames of the video) to identify shot transitions for a balance between computational efficiency and detection accuracy. A second threshold is determined based on the video and used to detect cut transitions. Additionally, a third and fourth threshold are determined based on the video and based on a particular section of the video and used to detect a gradual transition for the particular section. Results from the second shot transition detector can additionally be used to determine a set of candidates of key frames of the shots. Results from shot segmentation system and from key shot detection are used by one or more downstream systems (e.g., video analytics services and/or video editors).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

The accompanying drawings, which are incorporated in and constitute a part of this disclosure, illustrate various aspects of the present invention. In the drawings:

FIG. 1 depicts an operating environment for providing efficient shot transition detection of a video according to an example;

FIG. 2A depicts a cut transition between shots included in a video according to an example;

FIG. 2B depicts a gradual transition between shots included in a video of according to an example;

FIG. 3 depicts operations of an example method for providing efficient shot transition detection of a video according to an example;

FIG. 4 depicts an indication of transitions between shots according to an example;

FIG. 5 depicts an indication of a gradual transition between shots according to an example; and

FIG. 6 is a block diagram illustrating example physical components of a computing device with which aspects of the invention may be practiced.

### DETAILED DESCRIPTION

A shot is a single camera footage capturing a specific angle, place, and/or subject(s) in one or a sequence of image frames of a video. Shots can be grouped together to form a scene representing a larger unit of a video. A scene of a video refers to a unit of storytelling and is one continuous shot or is comprised of a sequence of shots. In some examples, a scene includes a sequence of events and/or dialogue occurring in a specific location and time, oftentimes involving one or more characters. For instance, there may be a scene of two people talking, where each instance where the camera focuses on a different person is considered a different shot. A change between shots is referred to as a transition. A transition can be via a cut transition, which is characterized by an abrupt change without a transition effect, or a gradual transition, such as a zoom, fade, dissolve, flip, pan, etc., between shots that occurs over multiple frames.

Transition detection and shot segmentation are fundamental processes in video analysis, where shots operate as a building block for various video analytics services. For instance, shots provide a manageable and efficient way to divide and evaluate content of a video into coherent temporal portions. These portions (shots) are provided as input into various video analytics models, where various insights can be retrieved from the video. For instance, analytics models that perform face/object detection, face/object identification, object continuity tracking, optical character recognition (OCR), content moderation, labels identification, scene segmentation, keyframe extraction, shot type detection, textual logo detection, summarization, etc., can be performed on coherent portions of the video, rather than on the video in entirety or on non-coherent portions of the video.

A shot transition detector evaluates visual features of frames to determine when a shot changes in a video. Some types of transitions are easier to detect than others. For instance, a cut transition is characterized by an abrupt change in visual features between two frames (e.g., without a transition effect). A cut transition can typically be detected with higher probability than a gradual transition, which progresses over a plurality of frames to change from one shot to a next shot in a video. Gradual transitions between frames, such as zooming, fading, dissolving, flipping, wiping, crossfading, and sliding, can be challenging to detect and distinguish between adjacent frames.

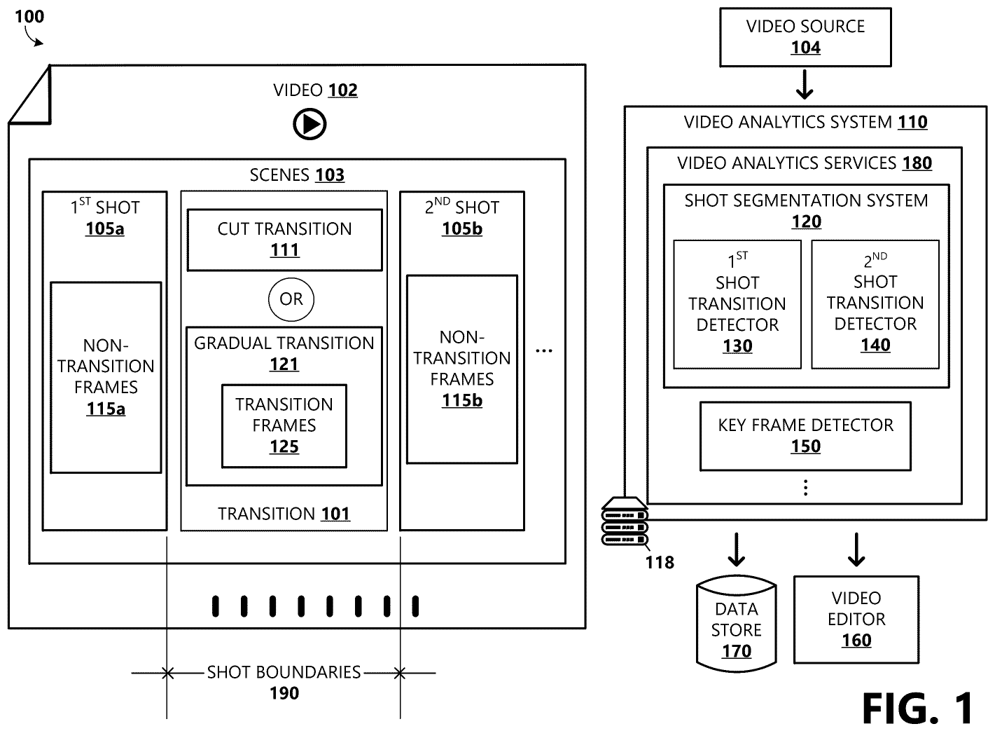

An artificial intelligence (AI) model-based transition detector is designed to identify shot transitions in video sequences by analyzing visual differences between frames. For instance, a neural network shot transition detector is a type of shot transition detector that uses three-dimensional convolutional neural networks to determine a score representing the probability that a frame is part of a shot transition based on an extent of visual differences between the frame and adjacent frames. The AI model-based shot transition detector provides more accurate results than a traditional shot transition detector, particularly when detecting gradual transitions; however, the AI model-based shot transition detector consumes more computational power, resources, and runtime than the traditional shot transition detector. Accordingly, a shot segmentation system and method are described herein that provides efficient shot transition detection for shot segmentation of a video using a combination of the traditional and the AI model-based shot transition detectors in multiple stages and using dynamic thresholds to detect cut transitions and gradual transitions. These and other examples are described below with reference to FIGS. 1-6.

With reference now to FIG. 1, an operating environment 100 is depicted in which a video analytics system 110 including a shot segmentation system 120 is implemented according to an example. The video analytics system 110 is representative of a local application or a cloud application built on various video analytics services 180 that extract insights from a video 102. In an example, the video analytics system 110 includes one or more server computer devices 118 supporting video analysis. The server computer devices 118 include web servers, application servers, network appliances, dedicated computer hardware devices, virtual server devices, personal computers, a system-on-a-chip (SOC), or any combination of these and/or other computing devices known in the art. As will be described herein, the video analytics system 110 and shot segmentation system 120 operate to execute a number of computer readable instructions, data structures, or program modules to provide efficient shot transition detection for segmenting a video 102. Each of the video analytics system 110, the shot segmentation system 120, and other video analytics services 180 are illustrative of a software application, system, or module that operates on a server computer device 118 or across a plurality of server computer devices 118.

In examples, a video 102 is received from a video source 104 and includes video data in a video coding format. The video 102 may represent an entire video or a portion or segment of the entire video. In some examples, the video 102 further includes audio data in an audio coding format, synchronization information, subtitles, and/or metadata. The video data is typically represented as a series of images captured by a camera, where each image is a frame. An uninterrupted sequence (e.g., from production or video editing) of frames that capture a specific angle, location, and/or character(s) is referred to as a shot 105 (e.g., a first shot 105a or a second shot 105b).

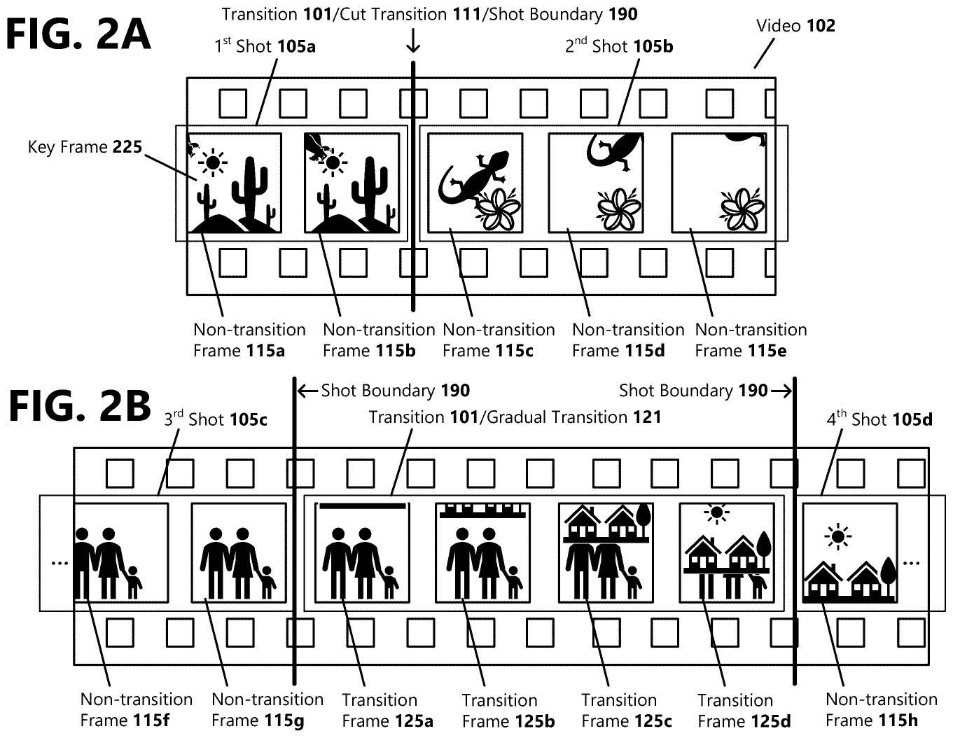

A change between shots 105 is referred to as a transition 101. In some examples, and as depicted in FIG. 2A, the transition 101 is a cut transition 111 characterized by an abrupt change in visual features from a first shot 105a to a second shot 105b (e.g., frames change without a transition effect.) The frames included in the two shots 105 are referred to as non-transition frames 115a-115e (collectively, non-transition frames 115). For instance, a cut transition 111 may be distinguished by a shift in visual content, color, pattern, and/or other visual elements in the first set of non-transition frames 115a and 115b and a second set of non-transition frames 115c-115e. In other examples, and as depicted in FIG. 2B, the transition 101 between shots 105 (e.g., shot 105d and shot 105e) is a gradual transition 121 in visual features, such as a zoom, fade, dissolve, flip, pan, etc., that occurs over multiple frames, referred to herein as transition frames 125 (e.g., transition frames 125a-125d).

With reference again to FIG. 1, the shot segmentation system 120 is one example service of a video analytics service 180 included in the video analytics system 110. The shot segmentation system 120 is operative to detect, based on visual features, shots 105 and transitions 101 between shots 105 in a video 102. In some implementations, the shot segmentation system 120 includes a first shot transition detector 130 representing a traditional shot transition detector including one or a combination of algorithms that determines when a shot 105 changes based on visual features extracted from frames, such as color histograms. Comparing the color histogram of two adjacent frames can indicate if there is a difference in the shots 105 to which they belong. In examples, the first shot transition detector 130 is capable of detecting cut transitions 111 in a video 102 with a high probability. In further examples, the first shot transition detector 130 is less capable of detecting non-cut transitions (i.e., gradual transitions 121 over a plurality of transition frames 125) with a high probability.

In some implementations, the shot segmentation system 120 further includes a second shot transition detector 140 representing an AI model-based shot transition detector (e.g., a neural network (NN) shot transition detector) to further detect shot transitions 101 in a video 102. A function of an AI model-based transition detector is to determine a probability that a frame 125 is part of a shot transition 101. This is achieved by examining the extent of visual differences between the frame 125 and its adjacent frames 125. The AI model-based transition detector assigns a score to each frame 125, indicating the likelihood of it being part of a transition 101. An NN shot transition detector utilizes neural networks to analyze visual differences. For instance, 3D Convolutional NNs (3D CNNs) capture spatial and temporal features, enabling the NN shot transition detector to understand complex patterns of visual differences. An example illustrative NN shot transition detector is the TransnetV2 deep learning-based model. In some examples, an NN shot transition detector is trained using labeled training data, where the correct transition labels are provided. The NN shot transition detector learns to predict these labels based on visual differences. Pre-trained NN shot transition detector models on large datasets are fine-tuned on specific shot transition detection tasks, improving performance with less data. In reinforcement learning scenarios, the NN shot transition detector can be trained to optimize a reward function. In other examples, the NN shot transition detector can learn by analyzing data without explicit labels, identifying patterns and anomalies that may indicate transitions 101.

In examples, the second shot transition detector 140 outputs a determination (e.g., binary indication or score) indicating whether a frame is part of a transition 101 or not. In further examples, the output of the second shot transition detector 140 includes a probability of each determination. In examples, an AI model-based shot transition detector is more capable of detecting both cut transitions 111 and gradual transitions 121 than a traditional shot transition detector; however, the AI model-based shot transition detector 140 consumes more computational power, compute resources (e.g., Graphics Processing Units (GPUs), Neural Processing Units (NPUs), Tensor Processing Units (TPUs)), and runtime than a traditional shot transition detector.

According to an aspect, the shot segmentation system 120 allows shot segmentation to be performed efficiently using the first shot transition detector 130 and the second shot transition detector 140 in a multi-stage process. This aspect offers a far greater efficiency with a similar effectiveness as running the AI-based shot transition detector alone with videos having a high number of cut transitions 111 versus gradual transitions 121. In examples, the shot segmentation system 120 uses the first shot transition detector 130 to determine a set of transition candidates for the second shot transition detector 140 to process (e.g., and skip non-candidate frames to conserve computational power, compute resources, and runtime). For instance, generating a transition candidate set prevents running the second shot transition detector 140 on every frame, which can be computationally expensive. The selection of these transition candidates is based on setting a first threshold (e.g., T_{T-CAND}) that is applied to visual features generated by the first shot transition detector 130. If the score of a particular frame exceeds the first threshold (T_{T-CAND}), the frame is considered as a transition candidate. In examples, the first threshold (T_{T-CAND}) used for the first shot transition detector 130 is set such that it is more permissive in flagging potential transitions for the following, more determinative, reviews by the second shot transition detector 140. In some examples, a transition candidate includes a segment of frames including the particular frame that exceeds the threshold.

According to another aspect, the shot segmentation system 120 determines and applies a plurality of dynamic thresholds to visual features generated by the second shot transition detector 140 in multiple stages to identify cut transitions 111 and gradual transitions 121 from the transition candidate set. Each stage is performed to identify anomalies in the visual features data at an intensity level that is relevant to that stage (e.g., based on the dynamic threshold). For instance, the dynamic thresholds are determined per video 102 and per each segment of visual features data using a statistical test. In one example, visual features data is converted into a Z-score to understand the relative position of each visual feature data point in comparison with other visual feature data points. The Z-score refers to the number of standard deviations by which the value of a raw score (i.e., an observed value or data point) is above or below the mean value of what is being observed or measured. Raw scores above the mean have positive standard scores, while those below the mean have negative standard scores. In other examples, another type of anomaly detection method is used by the shot segmentation system 120, such as clustering (e.g., self-organizing maps (SOMs), k-means clustering, or expectation maximization (EM)), classification (e.g., one-class support vector machines (OCSVMs)), statistical (e.g., regression models), deep learning (e.g., autoencoders, sequence-to-sequence models, generative adversarial networks (GANs), or variational autoencoders (VAEs)), etc.

In some implementations, the computational load of using the second shot transition detector 140 can be reduced with minimal impact on the accuracy of shot transition detection by skipping one or more frames and analyzing a determined subset of transition candidates. If greater accuracy is needed and/or to verify accuracy of optimization techniques, skipped frames can be analyzed in a subsequent pass or iteration. In further implementations, the second shot transition detector 140 is run on a subset of frames of a video 102 (e.g., a half, a third, a fourth) in addition to the set of transition candidates or the subset of transition candidates. The number of frames analyzed by the second shot transition detector 140 and the number of iterations can be adjusted for a balance between computational efficiency and detection accuracy.

In some examples, output from the shot segmentation system 120 includes an indication of shots 105 in the video 102. In some examples, shots 105 are indicated by a list of shot boundaries 190 that define starting and ending points (e.g., a starting frame and an ending frame) of each shot 105. For instance, a shot boundary 190 includes the start frame and end frame of the shot 105 and marks the start or end of the transition 101 from one shot 105 to another. As an example, and with reference again to FIG. 2B, if a third shot 105c ends at non-transition frame 115g and a fourth shot 105d starts at non-transition frame 115h, then the frames between the shot boundaries 190 of the third and fourth shots 105c and 105d are transition frames 125a-125d representing a gradual transition 121 from the third shot 105c to the fourth shot 105d. For instance, the gradual transition 121 may be a fade, dissolve, pan, or other type of gradual transition 121. Identifying shot boundaries 190 is a fundamental step in video analysis as it helps in understanding the structure and content of the video 102. In examples, shots 105 are a basis for further analysis of the video 102 by other video analytics services 180.

One example video analytics service 180 that uses output from the shot segmentation system 120 includes a key frame detector 150. The key frame detector 150 is operative to select a non-transition frame(s) 115 that best represents each shot 105 (referred to herein as a key frame(s)) 125 (depicted in FIG. 2A). In examples, key frames 225 are selected based on various aesthetic properties (e.g., contrast, stableness, location of an object in a frame) and assigned an identifier. Key frame identifiers are included in metadata associated with a shot 105. According to an aspect, candidates for key frame detection are selected based on output from the second shot transition detector 140, where key frame detection is run only on the key frame candidates. Output from the second shot transition detector 140 includes scores that indicate whether a frame is part of a transition 101 or not. In examples, higher scores (e.g., above a dynamic threshold) correspond to frames that are highly likely to be transition frames 125. Higher scores may indicate movement, blurriness, and/or other attributes of a transition 101, which are unfavorable attributes of a key frame 225. Thus, lower scores may indicate frames that are not likely to include movement, blurriness, and/or other transitional attributes, which further indicate the frames are favorable candidates for key frame detection.

Another example video analytics service 180 that uses output from the shot segmentation system 120 includes a scene segmentation service operative to determine when a scene 103 changes in a video 102 based on visual features. A scene 103 depicts a single event (e.g., an occurrence or action) and it is composed of a series of consecutive shots 105, which are visually related. For instance, in a scene 103 depicting a birthday party (an event), a series of consecutive shots 105 may show guests arriving, a person blowing out candles, and people clapping and celebrating. In some implementations, the scene segmentation service determines a thumbnail for a scene 103. In some examples, one of the key frames 225 of an underlying shot 105 is selected as the scene thumbnail. The scene segmentation service segments the video 102 into scenes 103 based on color coherence or other visual attributes across consecutive shots 105 and determines a beginning and end time of each scene 103. Example features provided by other video analytics services 180 that use output from the shot segmentation system 120 include face detection, celebrity identification, account-based face identification, thumbnail extraction for faces, OCR, visual content moderation, labels identification, editorial shot type detection, observed people tracking, matched person, textual logo detection, etc.

In some examples, output from the shot segmentation system 120 and other video analytics services 180 are stored in a data store 170. For instance, insights derived from various analyses of a video 102 are stored as metadata in association with the video 102 in the data store 170. Insights, as used herein, refers to facts or information of relevance in content. Examples of insights include transcripts, OCR elements, objects, faces, topics, keywords, and similar details. In further examples, a user can browse, manage, and/or edit the video 102 based on the metadata, for instance, based on shots 105, scenes 103, key frames 225, and/or other insights determined by the video analytics system 110. In some examples, a video editor 160 is used to edit the video 102 based on the metadata.

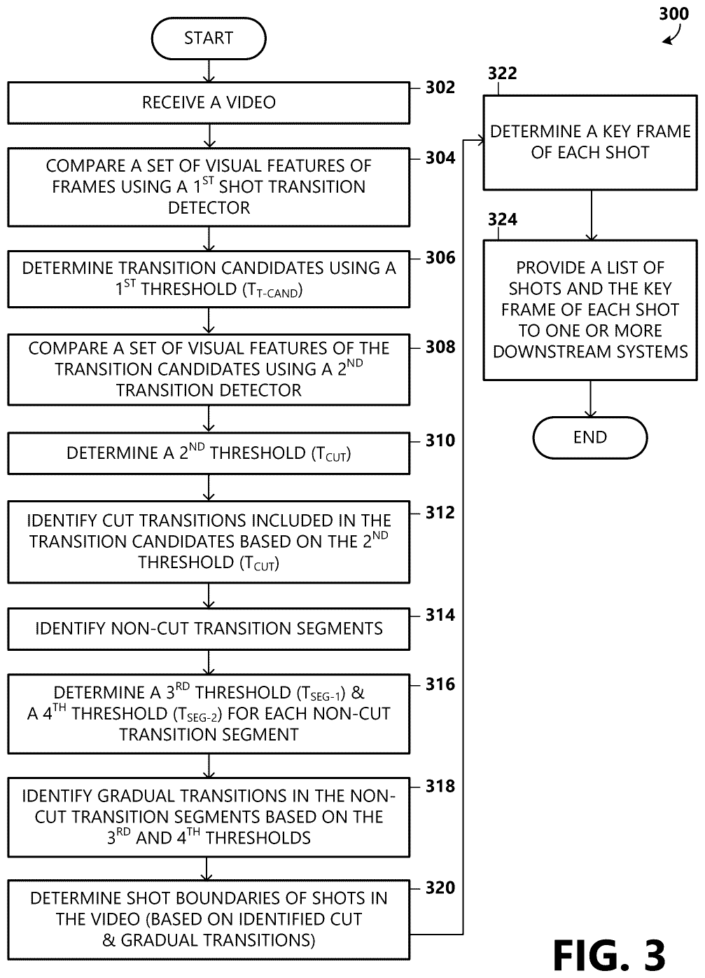

FIG. 3 depicts an example method 300 for providing efficient shot transition 101 detection for shot segmentation of a video 102 according to an example. The operations of method 300 may be performed by one or more computing devices, such as one or more computing devices included in the video analytics system 110. At operation 302, the video analytics system 110 uses the shot segmentation system 120 to analyze a video 102 provided by a video source 104. In some examples, the video 102 is an entire video 102 including a plurality of frames. In other examples, the video 102 is a portion of the entire video 102. In some implementations, a request is received, or an instruction is processed, to segment the frames of the video 102 into a plurality of shots 105. In examples, the shots 105 are defined by shot boundaries 190.

At operation 304, a first shot transition detector 130 (e.g., a traditional shot transition detector) is used to compare a set of visual features, such as colors, textures, and/shapes between adjacent frames of the video 102, and determine a first score representing an extent of the visual difference between frames. In some examples, the first shot transition detector 130 compares color histograms of adjacent frames and measures the extent of visual difference between the color histograms. The color histogram represents a distribution of colors in the frames and provides a statistical view of the color schemes of the frames. The measurement is provided as the first score, where a higher score represents a greater amount of visual difference between the frames, thus indicating a potential shot transition 101.

At operation 306, the shot segmentation system 120 evaluates the first scores generated by the first shot transition detector 130 to find anomalies in the signal. For instance, the shot segmentation system 120 determines whether the first score of a frame satisfies a first threshold (T_{T-CAND}). When the first threshold (T_{T-CAND}) is satisfied, the corresponding frame is selected as a transition candidate. In examples, the shot segmentation system 120 generates a set of transition candidates based on the evaluation of the first scores against the first threshold (T_{T-CAND}). The set of transition candidates is provided to the second shot transition detector 140 for further analysis and processing.

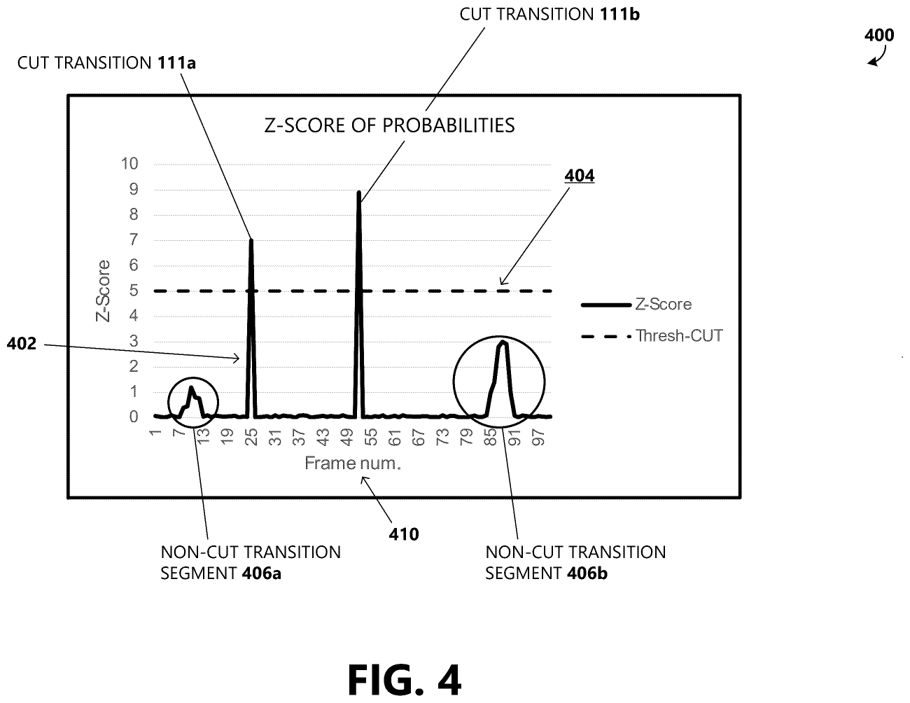

In association with the following descriptions of operations 308-314, reference may be made to FIG. 4, which depicts a graph 400 of described aspects. At operation 308, the second shot transition detector 140 is used to compare a set of visual features between a group of adjacent frames of the video 102 to determine the probability of a frame 410 to be part of a shot transition 101 based on an extent of the visual differences between frames 410. For instance, an AI-based shot detector, such as an NN shot detector, may be used to analyze the visual differences based on 3D CNNs. In some examples, the values are standardized (e.g., using a Z-score transformation) to generate a second score 402 (e.g., a Z-score) for each frame 410 in the set of transition candidates (or a subset of the transition candidates). In examples, utilization of computational resources is optimized by running the second shot transition detector 140 on the transition candidates (or the subset of the transition candidates) rather than on all frames 410 of the video 102. In some implementations, the second shot transition detector 140 is additionally run on a portion of frames of the video 102 (e.g., a half, a third, a fourth) in addition to the set of transition candidates. The size of the portion of frames analyzed by the second shot transition detector 140 and the number of iterations can be adjusted for a balance between computational efficiency and detection accuracy.

In some implementations, the method 300 starts at operation 308, where the set of transition candidates are received by the shot segmentation system 120. In other implementations, the method 300 starts at operation 310, where the second scores 402 are received by the shot segmentation system 120. For instance, the set of transition candidates and/or the second scores 402 may be determined in a previous pass or by a different system and provided to the shot segmentation system 120. At operation 310, a second threshold (T_{T-CUT}) 404 is determined to detect cut transitions 111. For instance, the second threshold (T_{T-CUT}) 404 is dynamically determined and set based on attributes of the video 102 and, in some examples, based on attributes of a portion of the video 102. As an example, a cut transition 111 is characterized by a sharp peak (e.g., a point in a sequence of scores where the corresponding score is higher than scores of its surrounding points) that may be more noticeable in some videos 102 than in other videos 102 (and/or portions thereof). In a video 102 where the sharp peaks are more discernable, the second threshold (T_{T-CUT}) 404 can be set relatively high. Conversely, in a video 102 where attributes cause transitions 101 to be less obvious, such as in a black-and-white video or a video with blurry or grainy images, the peaks of cut transitions 111 may be lower. Thus, the second threshold (T_{T-CUT}) 404 is dynamically set based on the video's characteristics, potentially where the second threshold (T_{T-CUT}) 404 is dynamically set to a lower value.

At operation 312, cut transitions 111 are identified based on second scores 402 that satisfy the second threshold (T_{T-CUT}) 404. As depicted in FIG. 4, a first cut transition 111a is identified as occurring at frame number 25. Thus, frame number 25 is identified as a starting point of a new shot 105 from a previous shot 105 including frame number 24. Additionally, a second cut transition 111b is identified as occurring at frame number 52, where frame number 52 is identified as a starting point of another new shot 105 from a preceding shot 105 including frame number 51.

At operation 314, non-cut transition segments 406 are identified. Non-cut transition segments 406 are characterized by peaks in the second scores 402 that do not satisfy the second threshold (T_{T-CUT}) 404 and that include a plurality of frames 410. For instance, and as depicted in FIG. 4, a first non-cut transition segment 406a and a second non-cut transition segment 406b are identified.

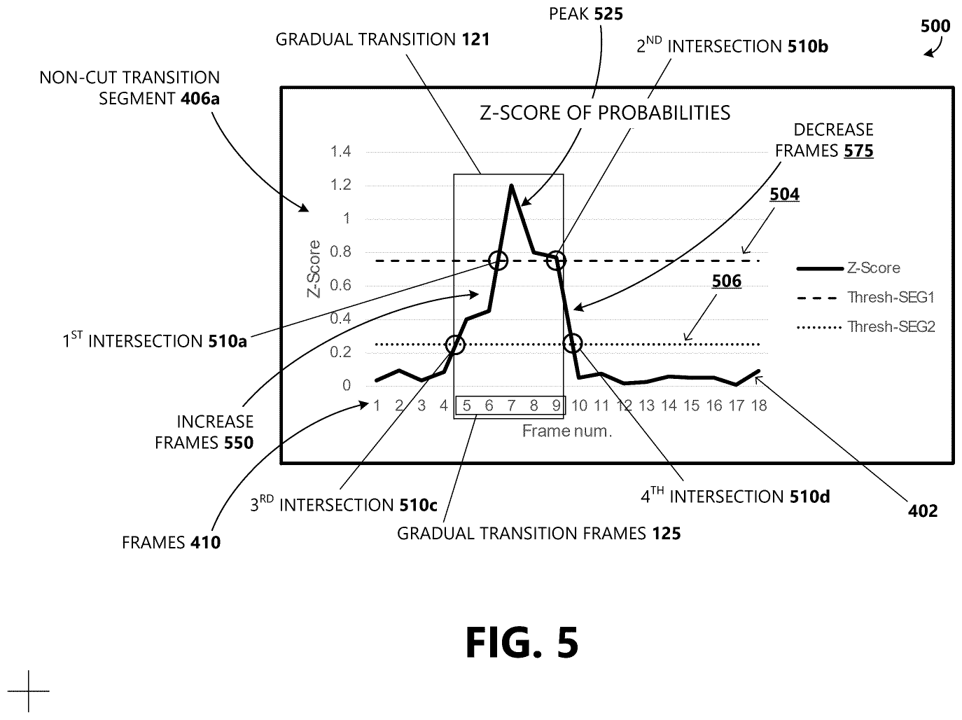

In association with the following descriptions of operations 316-318, reference may be made to FIG. 5, which depicts a graph 500 of described aspects. At operation 316, a third threshold (T_{SEG-1}) 504 and a fourth threshold (T_{SEG-2}) 506 are determined for each identified non-cut transition segment 406 to detect a gradual transition 121 in each non-cut transition segment 406. For instance, the third threshold (T_{SEG-1}) 504 and the fourth threshold (T_{SEG-2}) 506 are dynamically determined for each non-cut transition segment 406. These thresholds are calculated based on visual attributes that cause transitions 101 in the video 102, and specifically within the corresponding non-cut transition segment 406 to be less obvious. The third threshold (T_{SEG-1}) 504 and fourth threshold (T_{SEG-2}) 506 are reflective of the second scores 402, which are indicators of these visual attributes. If the second score 402 are lower within the non-cut transition segment 406, indicating less obvious visual attributes due to factors such as blurriness or graininess, the third threshold (T_{SEG-1}) 504 and fourth threshold (T_{SEG-2}) 506 may be set lower. This dynamic adjustment allows for more accurate detection of gradual transition frames 125. In examples, the third threshold (T_{SEG-1}) 504 is defined by a higher value (e.g., 90^{th} percentile of the second score 402) than the value of the fourth threshold (T_{SEG-2}) 506 (e.g., 70^{th} percentile of the second score 402).

At operation 318, the shot segmentation system 120 identifies gradual transitions 121 in the identified non-cut transition segments 406. In some implementations, the third threshold (T_{SEG-1}) 504 is first applied to detect a peak 525 of a gradual transition 121. For instance, the third threshold (T_{SEG-1}) 504 is used to identify a first intersection 510a and a second intersection 510b with the second score 402. When a first intersection 510a and a second intersection 510b with the second score 402 are identified, the fourth threshold (T_{SEG-2}) 506 is applied to determine a third intersection 510c and a fourth intersection 510d with the second score 402. In examples, the frames 410 that are included between the first intersection 510a and the fourth intersection 510d are identified as part of a gradual transition 121. In further examples, frames 410 included between the first intersection 510a and the second intersection 510b are identified as the peak 525 of the gradual transition 121, the frames 410 included between the third intersection 510c and the first intersection 510a are identified as increase frames 550 of the gradual transition 121, and the frames 410 included between the second intersection 510b and the fourth intersection 510d are identified as decrease frames 575 of the gradual transition 121. Collectively, the increase frames 550, the peak frames 525, and the decrease frames 575 are determined as the transition frames 125 of the gradual transition 121 between two shots 105.

At operation 320, shots 105 of the video 102 are determined based on the identified cut transitions 111 and gradual transitions 121. In some implementations, the shot segmentation system 120 generates a list of shots 105 defined by their shot boundaries 190. For instance, the shot boundaries 190 define the starting point and ending point of each shot 105, where frames included between different shots 105 are identified as frames of a transition 101 (i.e., transition frames 125).

At operation 322, a key frame 225 for each shot 105 is determined. In some examples, one or more key frame candidates for a key frame 225 are determined based on the second score 402 generated by the second shot transition detector 140. For instance, a lower threshold is determined, where second scores 402 below the lower threshold are identified as favorable candidates for key frames 225. The key frame detector 150 performs key frame detection on the one or more key frame candidates of a particular shot 105 to determine the key frame 225 for the particular shot 105 based on various aesthetic properties (e.g., contrast, stableness, location of an object in a frame). In some examples, the key frame detector 150 assigns a key frame identifier to each determined key frame 225, which is included in metadata associated with the corresponding shot 105.

At operation 324, a list of shots 105 defined by the shot boundaries 190 and the key frame identifiers is provided to one or more systems of or in communication with the video analytics system 110. For instance, the list of shots 105 and/or key frame identifiers are stored in a data store 170, used by one or more video analytics services 180, and/or used by a video editor 160 to edit the video 102.

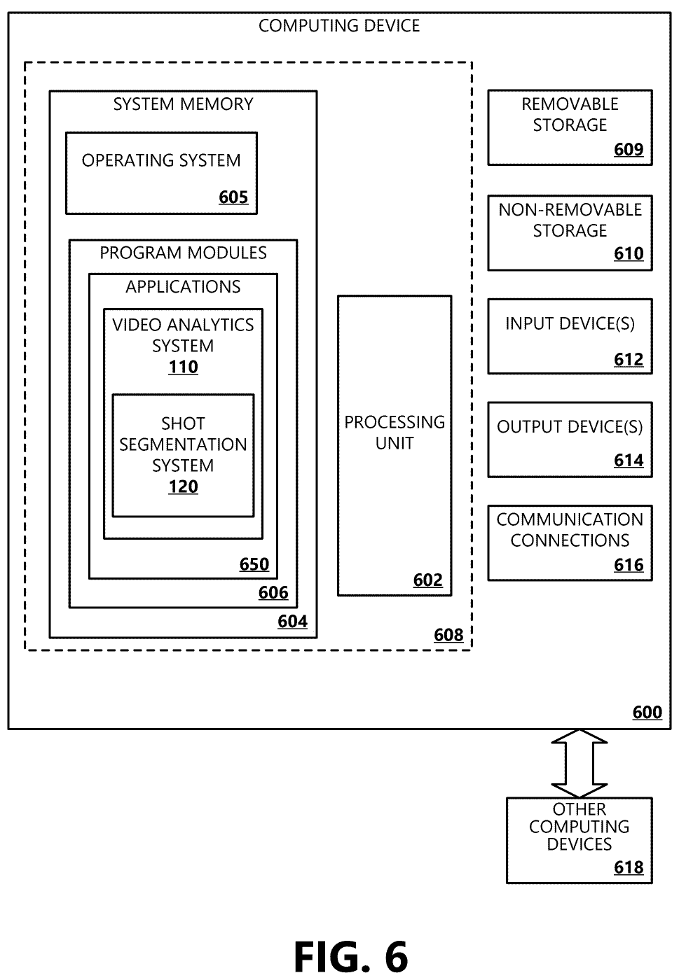

FIG. 6 and the associated description provides a discussion of an example operating environment in which examples of the disclosure may be practiced. However, the devices and systems illustrated and discussed with respect to FIG. 6 are for purposes of example and illustration and are not limiting of a vast number of computing device configurations that may be utilized for practicing aspects of the invention, described herein. FIG. 6 is a block diagram illustrating physical components (i.e., hardware) of a computing device 600 with which examples of the present disclosure may be practiced. The computing device components described below may be suitable for one or more video analytics services 180 included in the video analytics system 110 described above. In a basic configuration, the computing device 600 includes at least one processing unit 602 and a system memory 604. Depending on the configuration and type of computing device 600, the system memory 604 may comprise volatile storage (e.g., random access memory), non-volatile storage (e.g., read-only memory), flash memory, or any combination of such memories. The system memory 604 may include an operating system 605 and one or more program modules 606 suitable for running software applications 650, such as one or more components of the video analytics system 110.

The operating system 605 may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including one or more of the stages of the method 300 illustrated in FIG. 3. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing efficient shot transition 101 detection for shot segmentation of a video 102, may be operated via application-specific logic integrated with other components of the computing device 600 on the single integrated circuit (chip). Examples of the present disclosure may also be practiced using other technologies capable of performing logical operations such as, for example, AND, OR, and NOT, including mechanical, optical, fluidic, and quantum technologies.

The computing device 600 may also have one or more input device(s) 612 such as a keyboard, a mouse, a pen, a sound input device, a touch input device, a camera, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As will be understood from the foregoing disclosure, many technical advantages and improvements over conventional textless content matching technologies result from the present technology. For instance, the present technology provides an efficient method of detecting shot transitions with high accuracy. For instance, the second shot transition detector 140 provides more accurate results than the first shot transition detector 130, particularly when detecting gradual transitions 121. However, the second shot transition detector 140 also consumes more computational power, resources, and runtime than the first shot transition detector 130. In examples, computational power, resources, and runtime are used efficiently by running the second shot transition detector 140 on a set of transition candidates (or a subset of the set of transition candidates) rather than on all frames 410 of the video 102. Additionally, the computational load of using the second shot transition detector 140 can be further reduced with minimal impact on the accuracy of shot transition detection by skipping one or more frames 410 and analyzing a subset of frames 410. If greater accuracy is needed and/or to verify accuracy of optimization techniques, skipped frames 410 can be analyzed in a subsequent pass or iteration, where the size of the subset of frames, the size of the subset of transition candidates, and/or the number of iterations can be adjusted for a balance between computational efficiency and detection accuracy. Further, results of the second shot transition detector 140 can additionally be used to generate a set of key frame candidates, which can then be processed to determine key frames 225 of shots 105. Thus, computational power, resources, and runtime of the key frame detector 150 are reduced by running key frame detection on the set of key frame candidates rather than on all frames of all determined shots 105.

As will also be understood from the foregoing disclosure, in an aspect, the present technology relates to a computer-implemented method comprising: determining transition candidates of a set of frames of a video; generating first scores corresponding to a first comparison of visual features of the set of frames; identifying a non-cut transition segment included in the transition candidates; identifying a gradual transition in the non-cut transition segment by comparing the first scores with a first threshold and a second threshold; determining shot boundaries of shots in the set of frames based on the gradual transition; and generating a list of the shot boundaries.

In another aspect, the present technology relates to a system including a processor; and memory storing instructions that, when executed by the processor, cause the system to perform operations comprising: determining a set of transition candidates from frames of a video; performing a first comparison of visual features of the set of transition candidates using a first shot transition detector; generating a set of first scores based on results of the first comparison; identifying a non-cut transition segment included in the set of transition candidates; determining a first threshold and a second threshold for the non-cut transition segment; identifying a gradual transition in the non-cut transition segment based on the first threshold and the second threshold; determining shot boundaries of shots in the video based on the gradual transition; and generating a list of the shot boundaries.

In another aspect, the present technology relates to a video analytics system, comprising: a first shot transition detector; a second shot transition detector; a processor; and memory storing instructions that cause the video analytics system to perform operations comprising: performing a first comparison of visual features of frames of a video using the first shot transition detector; generating a set of first scores based on results of the first comparison; determining a first threshold based on the set of first scores; determining a set of transition candidates from the frames based on comparing the set of first scores with the first threshold; performing a second comparison of the visual features of the set of transition candidates using the second shot transition detector; generating a set of second scores based on results of the second comparison; determining a second threshold based on the set of second scores; identifying a cut transition included in the set of second scores based on comparing the set of second scores with the second threshold; identifying a non-cut transition segment included in the transition candidates by identifying a peak in the set of second scores that does not satisfy the second threshold; determining a third threshold and a fourth threshold for the non-cut transition segment; identifying a first intersection and a second intersection where the third threshold intersects the set of second scores; identifying a third intersection proximate the first intersection and a fourth intersection proximate the second intersection, where the third threshold and the fourth threshold intersect the set of second scores; identifying a gradual transition as the frames from the third intersection to the fourth intersection; determining shot boundaries of shots in the video based on the identified cut transition and the identified gradual transition; and generating a list of the shot boundaries.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A computer-implemented method, comprising:
determining transition candidates of a set of frames of a video;
generating first scores corresponding to a first comparison of visual features of the set of frames;
identifying a non-cut transition segment included in the transition candidates;
identifying a gradual transition in the non-cut transition segment by comparing the first scores with a first threshold and a second threshold;
determining shot boundaries of shots in the set of frames based on the gradual transition; and
generating a list of the shot boundaries.

2. The method of claim 1, wherein identifying the gradual transition comprises:
identifying a first intersection and a second intersection where the first threshold intersects the first scores;
identifying a third intersection proximate the first intersection and a fourth intersection proximate the second intersection, where the first threshold and the second threshold intersect the first scores; and
identifying the gradual transition as the frames from the third intersection to the fourth intersection.

3. The method of claim 1, wherein:
determining the transition candidates comprises using a first shot transition detector to perform a second comparison; and
performing the first comparison comprises using a second shot transition detector, where the first comparison is more accurate than the second comparison.

4. The method of claim 1, further comprising:
determining the shots in the set of frames based on the shot boundaries; and
using the first scores to determine at least one key frame candidate for each of the shots.

5. The method of claim 4, further comprising determining, from the at least one key frame candidate, a key frame for each shot.

6. The method of claim 4, wherein the at least one key frame candidate is not included in the gradual transition.

7. The method of claim 1, wherein:
identifying the non-cut transition segment included in the transition candidates comprises identifying a peak in the first scores that does not satisfy a third threshold; and
the first threshold, the second threshold, and the third threshold are determined based on the first scores.

8. A system comprising:
a processor; and
memory storing instructions that cause the system to perform operations comprising:
determining a set of transition candidates from frames of a video;
performing a first comparison of visual features of the set of transition candidates using a first shot transition detector;
generating a set of first scores based on results of the first comparison;
identifying a non-cut transition segment included in the set of transition candidates;
determining a first threshold and a second threshold for the non-cut transition segment;
identifying a gradual transition in the non-cut transition segment based on the first threshold and the second threshold;
determining shot boundaries of shots in the video based on the gradual transition; and generating a list of the shot boundaries.

9. The system of claim 8, wherein identifying the non-cut transition segment comprises identifying a peak in the first scores that does not satisfy a third threshold.

10. The system of claim 8, wherein identifying the gradual transition comprises:
identifying a first intersection and a second intersection where the first threshold intersects the first scores;
identifying a third intersection proximate the first intersection and a fourth intersection proximate the second intersection, where the first threshold and the second threshold intersect the first scores; and
identifying the gradual transition as frames from the third intersection to the fourth intersection.

11. The system of claim 8, wherein the first shot transition detector is a neural network shot transition detector.

12. The system of claim 8, the operations further comprising:
determining the shots in the set of frames based on the shot boundaries; and
using the first scores to determine at least one key frame candidate for each of the shots.

13. The system of claim 12, the operations further comprising determining, from the at least one key frame candidate, a key frame for each shot.

14. The system of claim 12, wherein the at least one key frame candidate is not included in the gradual transition.

15. The system of claim 8, wherein determining the set of transition candidates comprises:
performing a second comparison of the visual features of the frames using a second shot transition detector;
generating a set of second scores based on results of the second comparison; and
determining the set of transition candidates based on comparing the set of second scores with a third threshold.

16. The system of claim 15, further comprising:
identifying a cut transition included in the set of second scores based on comparing the set of second scores with a fourth threshold;
determining the third threshold based on the second scores; and
determining the first threshold, the second threshold, and the fourth threshold based on the first scores.

17. A video analytics system, comprising:
a first shot transition detector;
a second shot transition detector;
a processor; and
memory storing instructions that cause the video analytics system to perform operations comprising:
performing a first comparison of visual features of frames of a video using the first shot transition detector;
generating a set of first scores based on results of the first comparison;
determining a first threshold based on the set of first scores;
determining a set of transition candidates from the frames based on comparing the set of first scores with the first threshold;
performing a second comparison of the visual features of the set of transition candidates using the second shot transition detector;
generating a set of second scores based on results of the second comparison;
determining a second threshold based on the set of second scores;
identifying a cut transition included in the set of second scores based on comparing the set of second scores with the second threshold;
identifying a non-cut transition segment included in the transition candidates by identifying a peak in the set of second scores that does not satisfy the second threshold;
determining a third threshold and a fourth threshold for the non-cut transition segment;
identifying a first intersection and a second intersection where the third threshold intersects the set of second scores;
identifying a third intersection proximate the first intersection and a fourth intersection proximate the second intersection, where the third threshold and the fourth threshold intersect the set of second scores;
identifying a gradual transition as the frames from the third intersection to the fourth intersection;
determining shot boundaries of shots in the video based on the identified cut transition and the identified gradual transition; and
generating a list of the shot boundaries.

18. The video analytics system of claim 17, wherein the second shot transition detector is a neural network shot transition detector.

19. The video analytics system of claim 17, further comprising a key frame detector; and
the operations further comprising:
determining the shots in the frames based on the shot boundaries;
using the set of second scores to determine at least one key frame candidate for each of the shots; and
determining, from the at least one key frame candidate, a key frame for each shot using the key frame detector.

20. The video analytics system of claim 17, the operations further comprising providing the list of the shot boundaries to at least one of:
a data store;
a video analytics service; or
a video editor.
